(19) United States
(12) Patent Application Publication
(10) Pub. No.: US 2019/0046293 A1
(43) Pub. Date: Feb. 14, 2019

(54) METHODS OF MANUFACTURE OF DENTAL APPLIANCES USING 3D PRINTING, AND PRODUCTS PRODUCED THEREFROM

(71) Applicant: Ormco Corporation, Orange, CA (US)

(72) Inventors: Bindu Saran A.P.A., Irvine, CA (US); Evan Yifeng Tsai, Rancho Cucamonga, CA (US); Jessica Elivier Aguilar Grande, Placentia, CA (US)

(21) Appl. No.: 16/056,663

(22) Filed: Aug. 7, 2018

Related U.S. Application Data
(60) Provisional application No. 62/542,771, filed on Aug. 8, 2017.

(51) Int. Cl. A61C 7/08; A61C 7/00; B33Y 80/00

(52) U.S. Cl. CPC A61C 7/08; A61C 7/002; B33Y 70/00; A61C 2201/002; B33Y 80/00

(57) ABSTRACT

Aspects of the disclosure relate to methods and systems for providing a unitary shell appliance for use in a course of treatment for a dental patient and being of controlled thickness. The unitary shell appliance may be formed to present cavities configured to receive teeth of one of an upper or lower arch of the patient when the appliance is positioned on the patient. The appliance may be formed to have a first portion engageable with any tooth selected from the arch of the patient on which the appliance is to be positioned and a second portion associated with another tooth of the arch. The appliance may be further formed with a first thickness and a second thickness. A difference between the first and second thicknesses may be used to apply different levels of force to different teeth.

### CROSS-REFERENCE TO RELATED APPLICATION

This application is a non-provisional of U.S. Provisional Patent Application No. 62/542,771 filed Aug. 8, 2017 entitled “METHODS OF MANUFACTURE OF DENTAL APPLIANCES USING 3D PRINTING, AND PRODUCTS PRODUCED THEREFROM” which is hereby incorporated by reference herein in its entirety.

### FIELD OF TECHNOLOGY

Aspects of the disclosure relate to 3D printing method of manufacture and products produced therefrom. More specifically, aspects of the disclosure relate to 3D printing method of manufacture of dental appliances and the products produced from such methods.

### BACKGROUND

Attempts to solve problems moving teeth with thermoformed appliances have been contemplated, however the disclosed solutions all suffer from limitations associated with thermoforming. Paragraphs [0053]-[0055] of Align Publication No. US20170007364 describes movement lag issues present in some cases due to forces between a specific portion of the appliance and a specific area of the teeth being too small or not in the correct direction to effect the desired tooth movement. This issue has been difficult to correct in thermoformed appliances and this specific Align application proposes a dual appliance assembly with each appliance layer having different material properties and/or structures.

Accordingly, there is a need for a better solution for providing an aligner, or other dental appliance, with variable characteristics. There is also a need to directly construct an appliance with the desired characteristics. While references are made in the application to appliances generally, and aligners specifically, the references to appliances in the application should be understood to apply to any suitable dental appliance.

There is a further need for providing greater control over the material properties, makeup and characteristics of a finalized appliance.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an elevational view of an appliance according to certain embodiments;

FIG. 2 shows a top-down view of an appliance according to certain embodiments;

FIG. 3 shows a portion of an appliance according to certain embodiments;

FIG. 4 shows another top-down view of an appliance according to certain embodiments;

FIG. 5 shows a top-down view of an appliance with a pontic according to certain embodiments;

FIG. 6 shows a section view of an appliance over a single tooth according to certain embodiments;

FIG. 7 shows a system for use with certain embodiments; and

FIG. 8 shows an illustrative flow chart according to certain embodiments.

### DETAILED DESCRIPTION OF THE DISCLOSURE

3D Imaging—Appliance with Selective Thickness

In some embodiments, a unitary shell appliance for use in a course of treatment for a dental patient and being of controlled thickness is provided. For the purposes of this application, the term “unitary”, when used in the context of an appliance, may be understood to define an appliance that is formed, such as by the process of 3D printing, as a single unit.

The unitary shell appliance may be formed to present cavities configured to receive teeth of one of an upper or lower arch of the patient when the appliance is positioned on the patient. The appliance may be further formed to have a first portion engageable with any tooth selected from the arch of the patient on which the appliance is to be positioned. The appliance may also be formed to have a second portion associated with another tooth of the arch.

In certain embodiments, the first portion of the appliance may be formed to be of a thickness selected from a range of thicknesses. The range of thicknesses may be different from a range of thicknesses of the second portion of the appliance. The difference between the range of thicknesses of the first portion and the range of thicknesses of the second portion may cause a level of force on a selected tooth to be different from the level of force applied by appliance to another tooth.

In some embodiments, the first portion of the appliance may be engageable with a substantial portion of the visible surface of the selected tooth when the appliance is positioned on the patient. In certain embodiments, the second portion of the appliance may be positioned adjacent the first portion of the appliance. In other embodiments, the second portion of the appliance may be positioned at a location spaced apart from a location of the first portion of the appliance.

In some embodiments, the first portion at its periphery may define a distinct line of demarcation between the thickness of the first portion and the thickness of the second portion. The periphery may define a controlled gradient of thicknesses relative to the thickness of the second portion.

### 3D Imaging—Integrally Formed Pontic

Some embodiments may relate to a unitary shell appliance for use in a course of treatment for a dental patient missing one or more teeth. Such patients may have a void in one of an upper or lower arch of the patient.

In such embodiments, the unitary shell appliance may include cavities configured to receive all teeth of an upper or lower arch of the patient when the unitary shell appliance is positioned on the patient. Such embodiments may also include an outer surface at the void. The outer surface at the void may preferably simulate the surface of a tooth being present at the void. The embodiments may further simulate a projection extending inwardly relative to the outer surface of the unitary shell appliance at the void into the void to at least partially fill the void. In some embodiments, the projection substantially fills the void. The projection is preferably substantially solid throughout.

The outer surface of the appliance at the void may preferably present wall portions and a crown portion formed of a material of a color similar to that of natural teeth. In alternative embodiments, the outer surface of the appliance at the void may preferably present wall portions and a crown portion coated with a material of a color similar to that of natural teeth.

### 3D—Formed of Different Material Properties

Certain embodiments may relate to a unitary shell appliance of controlled material properties for use in a course of treatment for a dental patient. The appliance may preferably include cavities configured to receive teeth of one of an upper or lower arch of the patient when the unitary shell appliance is positioned on the patient. The appliance may also include a first portion and a separate and distinct second portion spaced apart from the first portion. The material properties of the first portion may be selected from a range of properties. The range of properties may be different from the material properties of, or a range of material properties associated with, the second portion. The unitary shell appliance may have material properties include toughness, flexibility, coefficient of friction, hardness, tear resistance, tensile strength, compressive strength, color, transparency, translucency, elasticity, pliability and/or chemical resistivity.

In certain embodiments, the appliance has a labial surface portion, a lingual surface portion and an intermediate portion between the surface portions. The intermediate portion may be of different material properties and/or thickness from those of the surface portions.

In some embodiments, the labial surface portion may be of different material properties from those of the lingual surface portion.

In some embodiments, the first portion may be closely adjacent the second portion of the appliance. In some embodiments, the first portion may be at a location spaced apart from a location of the second portion.

Certain embodiments may include a first portion of the appliance which, at its periphery, defines a distinct line of demarcation between the material properties of the first portion and the material properties of the second portion.

The first portion, at its periphery, may further define a controlled gradient of properties relative to the properties of the second portion.

### 3D—Preformed Wall Edges for the Gingiva

Some embodiments of a unitary shell appliance for use in a course of treatment for a dental patient may include cavities configured to receive teeth of an upper or lower arch of the patient when the appliance is positioned on the patient. The appliance may further include a crown portion engageable with at least one crown of a tooth on one of an upper or lower arch of the patient and wall portions extending alongside the labial and lingual sides of the teeth of the arch when the unitary shell appliance is positioned on a patient. The wall portions may be formed to have end edges remote from the crown portion. The end edges may be formed with a profile that generally corresponds to a profile of the surface of the gingiva surrounding the teeth of the arch on which the unitary shell appliance is to be positioned. The end edges may be rounded.

The end edges of the wall portions extend closely adjacent to, but spaced apart from, the surface of the gingiva to avoid contact with the gingiva when the appliance is positioned on the patient.

In forming the appliance, a wall support may be built on a generally planar member, with the support structure presenting a contoured surface corresponding to the profile of the end edges and engageable with the end edges to support the wall portions.

The wall support may be formed from a material different from the shell appliance. The wall support may be subject to separation from the wall portions after the appliance is formed. Such separation may be obtained by mechanical reaction, electromagnetic interaction and/or physical force or any other suitable separation force-generating mechanism.

### A Single Appliance Treatment of Teeth

A unitary shell for use in a course of treatment for a dental patient may be formed to include cavities configured to receive teeth of an upper or lower arch of the patient when the appliance is positioned on the patient. The unitary shell appliance may be formed to present a treatment surface engageable by at least one tooth and defining a treatment position of the tooth.

The treatment surface may be at a first wall portion of the appliance at one of the lingual or labial sides of the appliance. The appliance may include a second wall portion. The second wall portion may be located at the cavity associated with the tooth and generally opposite the first wall portion across the cavity. The second wall portion may be configured to hold a biasing member for applying force to the tooth to move the toward the treatment surface. The biasing member may be a spring mounted at one end to the second wall portion. The biasing member may be a block of elastomeric material mounted, at one end, to the second wall portion.

Some exemplary embodiments of the disclosure include:
1. A unitary shell appliance for use in a course of treatment for a dental patient, the shell appliance comprising:

cavities configured to receive teeth of an upper or lower arch of the patient when the appliance is positioned on the patient;

a crown portion engageable with at least one crown of a tooth on one of an upper or lower arch of the patient and wall portions extending alongside the labial and lingual sides of the teeth of the arch when the unitary shell appliance is positioned on the patient; and

wherein the wall portions are formed to have end edges remote from the crown portion having a profile generally corresponding to a profile of the surface of the gingiva surrounding the teeth of the arch on which the unitary shell appliance is to be positioned.
2. The unitary shell appliance of embodiment 1 wherein the end edges of the wall portions extend closely adjacent to but spaced apart from the surface of the gingiva to avoid contact with the gingiva when the appliance is positioned on the patient.
3. The unitary shell appliance of embodiment 1 wherein in forming the appliance a wall support is built on a generally planar member, with a support structure presenting a contoured surface corresponding to the profile of the end edges and engageable with the end edges to support the wall portions.
4. The unitary shell appliance of embodiment 1 wherein the wall support is of a material different from the shell appliance.
5. The unitary shell appliance of embodiment 1 wherein the wall support is subject to separation from the wall portions after the appliance is formed by mechanical reaction, electromagnetic interaction or physical force.
6. The unitary shell appliance of embodiment 1 wherein the end edges are rounded.
7. A unitary shell for use in a course of treatment for a dental patient:

the unitary shell appliance being formed to present cavities configured to receive teeth of an upper or lower arch of the patient when the appliance is positioned on the patient;

the unitary shell appliance being formed to present a treatment surface engageable by at least one tooth and defining a treatment position of the tooth, the treatment surface being at a first wall portion of the appliance at one of the lingual or labial sides of the appliance; and

the appliance further being formed at a second wall portion of the appliance, said second wall portion being located at the cavity associated with the tooth and generally opposite the first wall portion across the cavity, said second wall portion configured to hold a biasing member for applying force to the tooth to move the tooth toward the treatment surface.
8. The unitary shell appliance of embodiment 7 wherein the biasing member is a spring mounted at one end to the second wall portion.
9. The unitary shell appliance of embodiment 7 wherein the biasing member is a block of elastomeric material mounted at one end to the second wall portion.
10. A unitary shell appliance for use in a course of treatment for a dental patient and being of controlled thickness:

the appliance being formed to present cavities configured to receive teeth of one of an upper or lower arch of the patient when the appliance is positioned on the patient;

the appliance further being formed to be engageable with at least one tooth selected from the arch of the patient on which the appliance is to be positioned, and having a first portion associated with one surface of the tooth and a second portion associated with another surface of the tooth; and

the first portion of the appliance being formed to be of a thickness selected from a range of thicknesses to be different from the thickness of the second portion of the appliance to apply a level of force on the tooth different from the level of force applied by the second portion on the tooth.
11. A method for treating a dental patient, the method using a unitary shell appliance in a course of treatment, the method comprising:

forming the appliance from a polymeric material, the forming comprising forming a shell of the appliance to a controlled thickness;

forming, in the appliance, cavities configured to receive teeth of one of an upper or lower arch of the patient when the appliance is positioned on the patient;

forming the appliance further to have a first portion engageable with a tooth selected from the arch of the patient on which the appliance is to be positioned and a second portion associated with another tooth of the arch; and

forming the first portion of the appliance to be of a thickness selected from a range of thicknesses to be different from the thickness of the second portion of the appliance, said forming the first portion of the appliance to be of a thickness selected from a range of thicknesses to be different from the thickness of the second portion of the appliance in order to apply a level of force on the selected tooth different from the level of force applied by the second portion on the other tooth of the arch.
12. The method of embodiment 11 wherein the first portion of the appliance is engageable with a substantial portion of the surface of the selected tooth when the appliance is positioned on the patient.
13. The method of embodiment 11 wherein the second portion of the appliance is positioned adjacent to the first portion of the appliance.
14. The method of embodiment 11 wherein the second portion of the appliance is positioned at a location spaced apart from a location of the first portion of the appliance.
15. The method of embodiment 11 wherein the first portion at its periphery defines a distinct line of demarcation between the thickness of first portion and the thickness of the second portion.
16. The method of embodiment 11 wherein the first portion at its periphery defines a controlled gradient of thicknesses relative to the thickness of the second portion.
17. A method for forming a unitary polymeric shell appliance for use in a course of treatment for a dental patient, the dental patient missing one or more teeth, thereby leaving a void in one of an upper or lower arch of the patient, the method for forming a unitary polymeric shell appliance comprising:

forming cavities configured to receive all teeth of an upper or lower arch of the patient when the appliance is positioned on the patient; and

forming an outer surface at the void, said forming an outer surface comprising simulating the surface of a tooth being present at the void; and forming a projection extending inwardly relative to the outer surface of the appliance at the void into the void to at least partially fill the void.
18. The method of embodiment 17 wherein the outer surface of the appliance at the void presents wall portions and a crown portion formed of a material of a color similar to that of natural teeth.
19. The method of embodiment 17 wherein the outer surface of the appliance at the void presents wall portions and a crown portion coated with a material of a color similar to that of natural teeth.
20. The method of embodiment 17 wherein the projection substantially fills the void.
21. The method of embodiment 17 wherein the projection is substantially solid throughout.
22. A method for forming a unitary shell appliance for use in a course of treatment for a dental patient, with the appliance being of controlled material properties, the shell appliance comprising:

forming cavities configured to receive teeth of one of an upper or lower arch of the patient when the appliance is positioned on the patient; and

forming a first portion and a separate and distinct second portion spaced apart from the first portion;

wherein the material properties of the first portion are selected from a range of properties; and

wherein the material properties of the second portion are selected from a range of properties that are different from the material properties of the first portion.
23. The method of embodiment 22 wherein the appliance has a labial surface portion, a lingual surface portion and an intermediate portion between the surface portions, with the intermediate portion being of different material properties from those of the surface portions.
24. The method of embodiment 22 wherein the appliance has a labial surface portion and a lingual surface portion, with the labial surface portion being of different material properties from those of the lingual surface portion.
25. The method of embodiment 22 wherein the first portion is adjacent the second portion of the appliance.
26. The method of embodiment 22 wherein the first portion is at a location spaced apart from a location of the second portion.
27. The method of embodiment 22 wherein the material properties include at least toughness, flexibility, coefficient of friction, hardness, tear resistance, tensile strength, compressive strength, color, transparency, translucency, elasticity, pliability and/or chemical resistivity.
28. The method of embodiment 22 wherein the first portion at its periphery defines a distinct line of demarcation between the material properties of the first portion and the material properties of the second portion.
29. The method of embodiment 22 wherein the first portion at its periphery defines a controlled gradient of properties relative to the properties of the second portion.
30. A method for forming a unitary polymeric shell appliance for use in a course of treatment for a dental patient, the method comprising:

forming cavities configured to receive teeth of an upper or lower arch of the patient when the appliance is positioned on the patient;

forming a crown portion engageable with at least one crown of a tooth on one of an upper or lower arch of the patient and wall portions extending alongside the labial and lingual sides of the teeth of the arch when the appliance is positioned on a patient; and

wherein the wall portions are formed to have end edges remote from the crown portion, the end edges having a profile generally corresponding to a profile of the surface of the gingiva surrounding the teeth of the arch on which the appliance is to be positioned.
31. The method of embodiment 30 wherein the end edges of the wall portions extend adjacent to but spaced apart from the surface of the gingiva to avoid contact with the gingiva when the appliance is positioned on the patient.
32. The method of embodiment 30 wherein, in forming the appliance, a wall support is built on a generally planar member, with the support structure presenting a contoured surface corresponding to the profile of the end edges and engageable with the end edges to support the wall portions.
33. The method of embodiment 30 wherein the wall support is of a material different from the shell appliance.
34. The method of embodiment 30 wherein the wall support is subject to separation from the wall portions after the appliance is formed by mechanical reaction, electromagnetic interaction or physical force.
35. The method of embodiment 30 wherein the end edges are rounded.
36. A method for providing a unitary shell for use in a course of treatment for a dental patient, the method comprising:

forming the appliance wherein the appliance presents cavities configured to receive teeth of an upper arch or lower arch of the patient when the appliance is positioned on the patient;

further forming the appliance to present a treatment surface engageable by at least one tooth and defining a treatment position of the tooth, the treatment surface being at a first wall portion of the appliance at one of the lingual or labial sides of the appliance; and

further forming at a second wall portion of the appliance, said second wall portion being located at the cavity associated with the tooth and generally opposite the first wall portion across the cavity, said second wall portion configured to hold a biasing member for applying force to the tooth to move the tooth toward the treatment surface.
37. The method of embodiment 36 wherein the biasing member is a spring mounted at one end to the second wall portion.
38. The method of embodiment 36 wherein the biasing member is a block of elastomeric material mounted at one end to the second wall portion.
39. A method for creating a digital file for use in manufacturing a dental appliance, the method comprising:

manipulating image data to convert an initial digital data set, said initial digital data set corresponding to an untreated tooth arrangement, into a desired final tooth arrangement, said manipulating comprising:
segmenting the teeth represented in the digital data set; and
using an algorithm to adjust the digital data set into a final digital data set that corresponds to the final treatment position;

generating intermediate digital data sets (positive tooth models) corresponding to successive tooth arrangements from the initial digital data set into the final digital data set;

calculating gingival boundary for all intermediate stages;

creating digital appliances incorporating the calculated gingival boundary for all intermediate stages; and

using a computer algorithm to determine the degree of thickness for at least one portion of each digital appliance, said determining in order to effect forces on at least one tooth to achieve desired tooth movement.
40. The method of embodiment 39, further comprising performing the determining the degree of thickness for at least one portion of each digital appliance for each respective intermediate stage of treatment.
41. The method of embodiment 39 further comprising using the computer algorithm to determine the thickness for all portions of each digital appliance.
42. The method of embodiment 39 wherein the step can be automated and system driven or, alternatively, manual input can be received from an authorized user of the system to alter thickness levels.
43. The method of embodiment 39 further comprising calculating gingival boundary for all intermediate stages as intermediate digital data sets are generated.
44. The method of embodiment 39 further comprising controlling a 3D printing fabrication machine to produce appliances for all intermediate stages of treatment in accordance with the created digital appliances, said controlling comprising utilizing calculated gingival boundary and thickness in the digital/virtual appliance model created in embodiment 1.
45. The method of embodiment 39 further comprising using post-processing to improve clarity and biocompatibility of the appliance, said post-processing comprising at least one of sanding, blasting and chemically treating.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

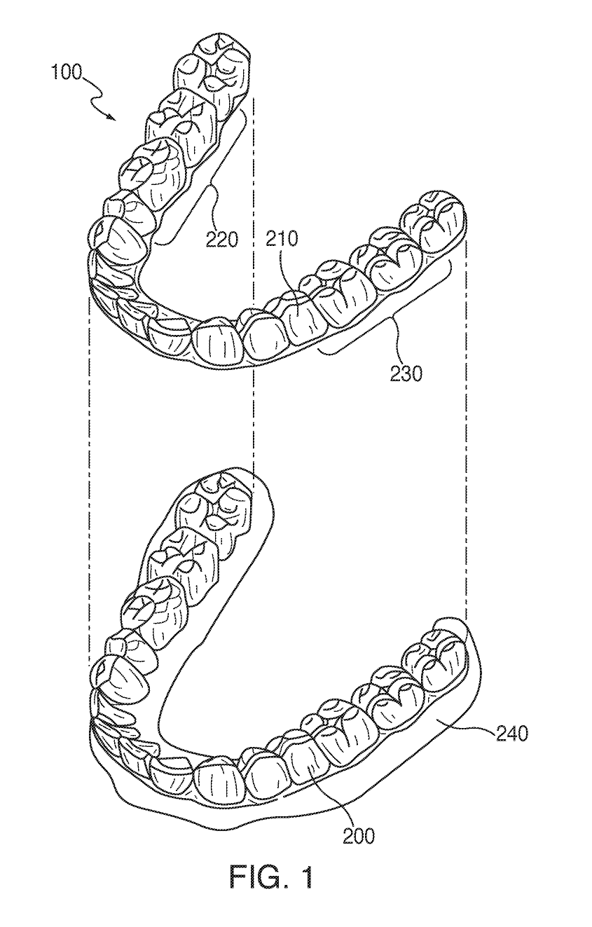

FIG. 1 shows an elevational view of an appliance, which may be an appliance, according to certain embodiments. Appliance 100 defines a plurality of cavities, each cavity or crown portion 210 is configured to receive a tooth when the appliance is applied to an upper or lower arch of the patient. Crown portion 210 may engage at least one crown of a tooth 200 on one of an upper or lower arch of the patient.

Appliance 100 may include wall portions 220 and 230. Wall portions 220 and 230 may be remote from crown portion 210. Wall portions 220 and 230 may have a profile generally corresponding to a profile of the surface of a patient's gingiva 240. The profile of wall portions 220 and 230 are designed so as not to irritate or impact the patient's gingiva 240 when the appliance is worn by the patient.

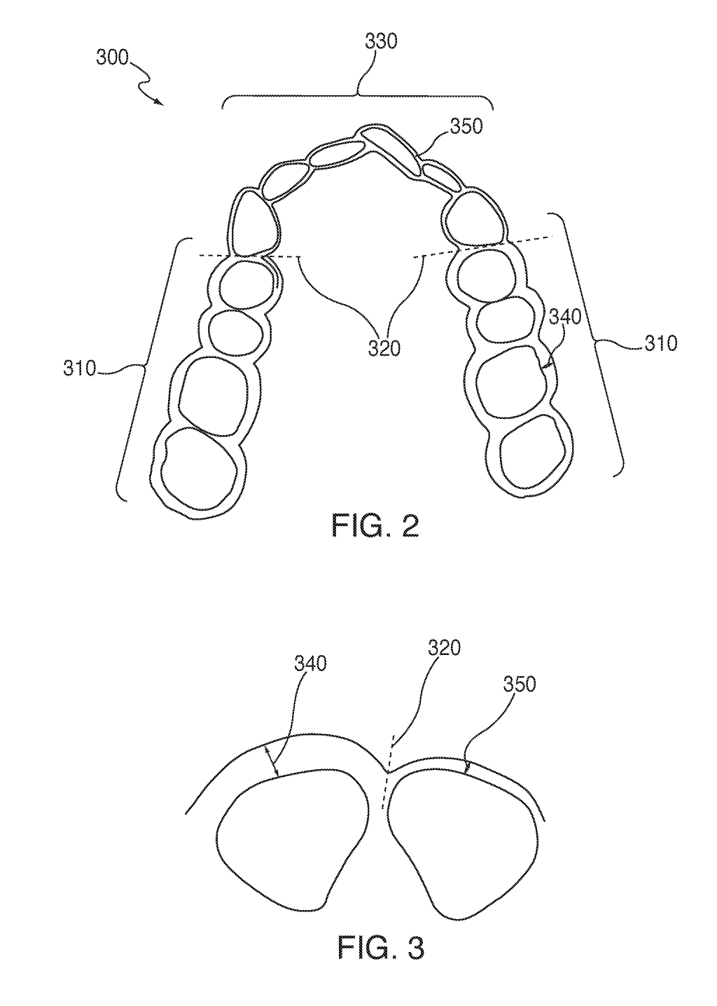

FIG. 2 shows a top-down view of an appliance according to certain embodiments. FIG. 2 shows first portions of the appliance 310 being formed from a first thickness. Portions 310 may preferably be engageable with any tooth from among the molars or the pre-molars on which the appliance is to be positioned.

FIG. 2 also shows a second portion 330 which is engageable with at least one other tooth selected from the arch of the patient. It should be noted that while first portions 310 are shown as engageable with the molars and premolars, and second portion 330 is shown as engageable to the incisors, other configurations of the first and second portions are possible and within the scope of this disclosure. For example, in accordance with an alternative arrangement, portion 310 can be shown as engageable with a single tooth on the patient's arch and portion 330 can be shown as engageable with any other tooth or group of teeth on the patient's arch. Portions 310 and 330 define one or more crown portions on an aligner whereby the thickness of the aligner material that makes up the respective portions is different.

A line of demarcation 320 is shown between first and second portions 310 and 330. A first thickness of the appliance corresponding to first portion 310 is illustratively indicated at 340. A second thickness of the appliance corresponding to the second portion 330 is illustratively indicated at 350.

It should be noted that each of thickness 340 and 350 may preferably be controllably formed in a 3D Printing process. Exemplary ranges for such thicknesses may be between 0.45 mm and 1.05 mm, from 0.65 mm to 0.85 mm or other suitable range. It should be noted that each of thicknesses 340 and 350 may be different—e.g., thickness 340 may be formed to be 0.65 mm or less while thickness 350 may be formed to 0.85 mm or more—all depending on the application for which the appliance is being used. For example, each of thicknesses 340 and 350 may be defined by two non-overlapping ranges or thicknesses. In other embodiments, each of thicknesses 340 and 350 may be defined by two non-overlapping ranges or thicknesses.

FIG. 3 shows a portion of an appliance according to certain embodiments. Specifically, FIG. 3 shows line of demarcation 320, thickness 340 and thickness 350. It should be noted that thicknesses 340 and 350 may preferably be different and line of demarcation 320 may provide a distinct boundary between the two different thicknesses.

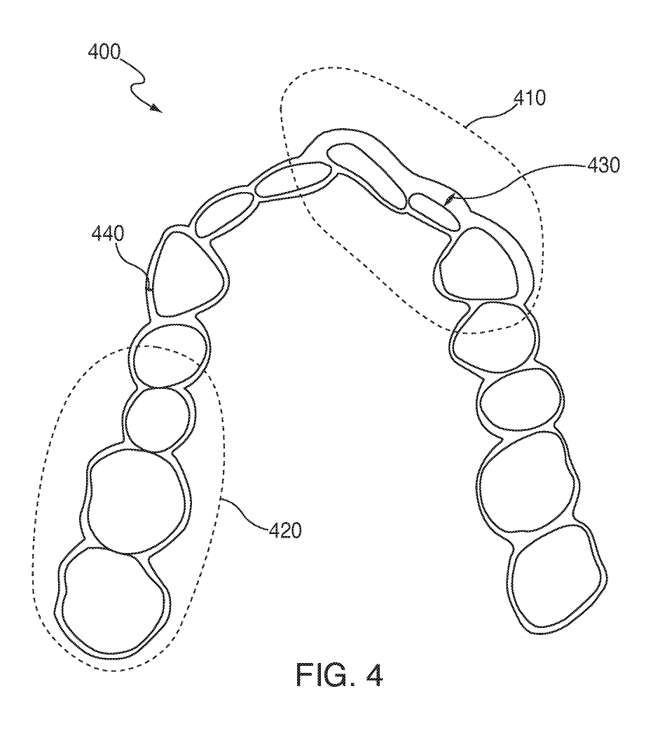

FIG. 4 shows another top-down view of an appliance 400 according to certain embodiments. FIG. 4 shows that the portion 410 corresponding to the incisors may preferably include a thickness 430. Portion 420 corresponding to the molars and pre-molars may preferably include a second thickness 440. Second thickness 440 may preferably be smaller than first thickness 430. As described above, the relative thicknesses of the portions of the appliances described herein may preferably be distinct and different from one another. Furthermore, the thicknesses of the portions of the appliances described herein are not necessarily tied to a single configuration and, in fact, may be different according to the patient's specific malocclusion(s) that the aligner is targeted to correct during the course of treatment. Conventional aligner staging software for treatment planning and manufacturing systems that relied on conventional thermoforming techniques were limited to producing aligners that could reasonably be thermoformed. Limitations in the thermoforming process, such as the ability to control the thickness or material composition of specific portions of the finalized aligner, translated into limitations on forces that could be applied to the teeth by a single aligner stage. These limitations ultimately resulted in longer treatment times to arrive at a desired post-treatment state or alternatively, required precise placement of attachments to specific teeth to achieve forces that the aligner itself could not be designed to reach without the respective attachment(s).

In accordance with the present invention, fabricating an aligner using 3D printing permits for more robust designs. For example, in the course of developing a treatment plan for producing aligners to move a patient's teeth from an initial pre-treatment state to a final post-treatment state, the thickness or material composition of specific portions of the aligner can be selectively controlled to apply specific forces to the teeth.

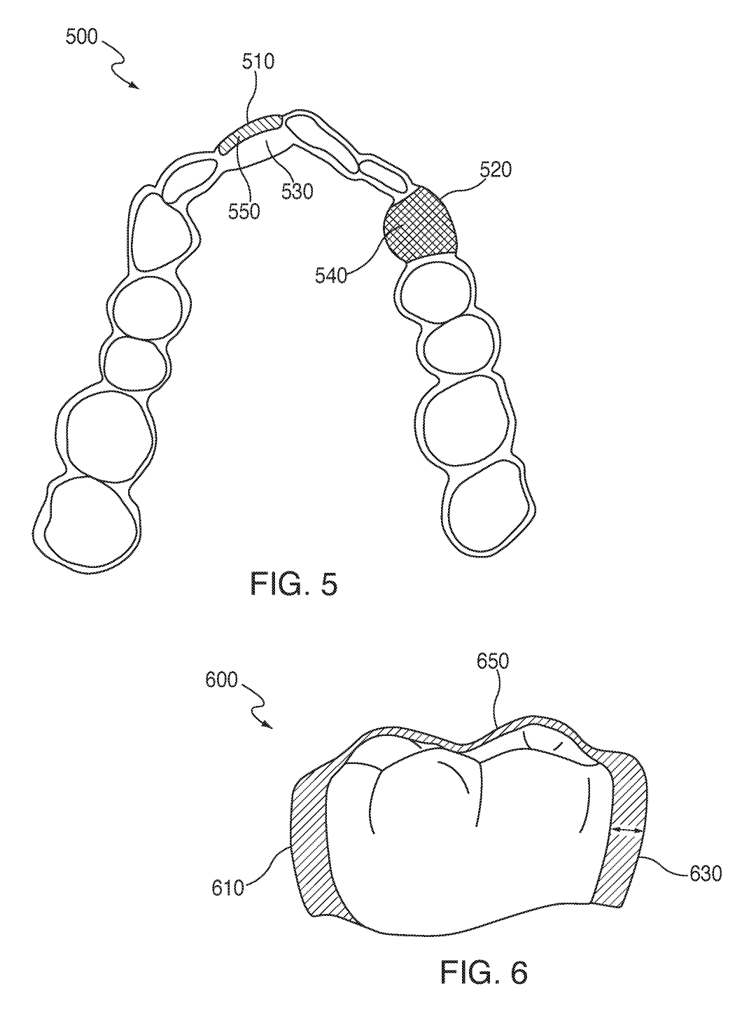

FIG. 5 shows a top-down view of an appliance 500 with a pontic according to certain embodiments. Appliance 500 may preferably include projection 540 and 550. Projections 540 and 550 may preferably correspond to voids such as void 530 in the arches of a patient. These voids may represent missing teeth in the patient's dentition. Projections 550 and 540 may preferably serve to present outer surfaces 510 and 520, respectively, in order to simulate the surface of a tooth.

Accordingly, when unitary shell appliance 500 is applied to the patient's arch during treatment the outer surfaces 510 and 520 of the respective pontics 550 and 540 will provide the appearance of a tooth. Projections 550 and 540 may be integrally formed as part of unitary shell appliance 500 and may further be formed to substantially or partially fill any void in the patient's dentition that would otherwise be received by a tooth which a particular patient is missing.

FIG. 6 shows a section view of an appliance 600 over a single tooth according to certain embodiments. FIG. 6 shows a lingual surface portion 610, a labial surface portion 630 and an intermediate surface portion 650 of appliance 600. It should be noted that, because intermediate surface portion 650 typically corresponds with the biting surface of the tooth, intermediate surface portion 650 may be formed to have a thickness of a smaller magnitude than the respective thicknesses of lingual surface portion 610 and labial surface portion 630.

It should be noted that, because intermediate surface portion 650 typically corresponds with the biting surface of the tooth that typically comes into contact with tooth or teeth on the opposing arch of the patient when the patient bites down, intermediate surface portion 650 may be formed to have a thickness of a smaller magnitude than the respective thicknesses of lingual surface portion 610 and labial surface portion 630. This smaller magnitude or thickness of the intermediate surface portion 650 provides a smaller degree of interference with the patient's natural bite making the unitary shell appliance or aligner formed therefrom more comfortable for the patient to wear, while the higher degree of thickness of the lingual and labial surface portions do not degrade performance of the aligner's ability to apply the requisite degree of force to the tooth necessary to influence movement in accordance with the planned treatment.

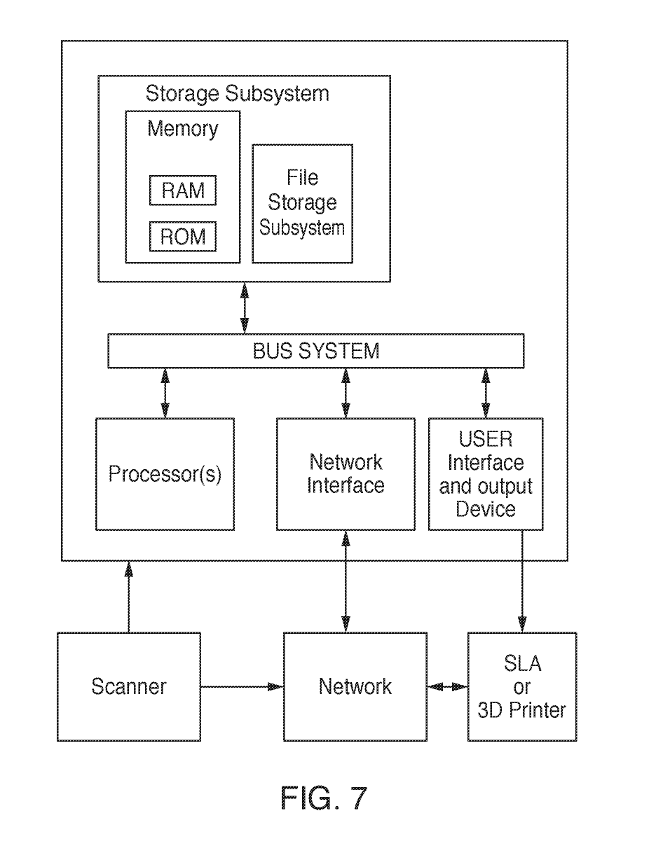

FIG. 7 shows a system for use with certain embodiments. Specifically, FIG. 7 shows an illustrative diagram of a computer system. The computer system may have a processor for controlling the operation of the system and its associated components, and may include RAM, ROM and user input/output device. The processor will also execute all software running on the computer—e.g., the operating system. Other components commonly used for computers such as EEPROM or Flash memory or any other suitable components may also be part of the computer system.

The memory may be comprised of any suitable permanent storage technology—e.g., a hard drive. The memory 115 stores software including the operating system any application(s) along with any data needed for the operation of the system. Alternatively, some or all of computer executable instructions may be embodied in hardware or firmware (not shown). The computer system executes the instructions embodied by the software to perform various functions.

Input/output (“I/O”) devices may include connectivity to a microphone, keyboard, touch screen, and/or stylus through which a user of computer may provide input, and may also include one or more digital output devices for providing instructions to a stereolithography (SLA) or 3D Printer.

The computer system may be connected to other device systems via a network interface.

The computer system may operate in a networked environment supporting connections to one or more remote computer terminals. The terminals may be personal computers or servers that include many or all of the elements described above relative to the computer system. The network connections depicted in FIG. 7 may include a local area network (LAN) and a wide area network (WAN), but may also include other networks. When used in a LAN networking environment, the computer system may be connected to a LAN through a LAN interface or adapter. When used in a WAN networking environment, the computer system may include a modem or other means for establishing communications over WAN, such as Internet.

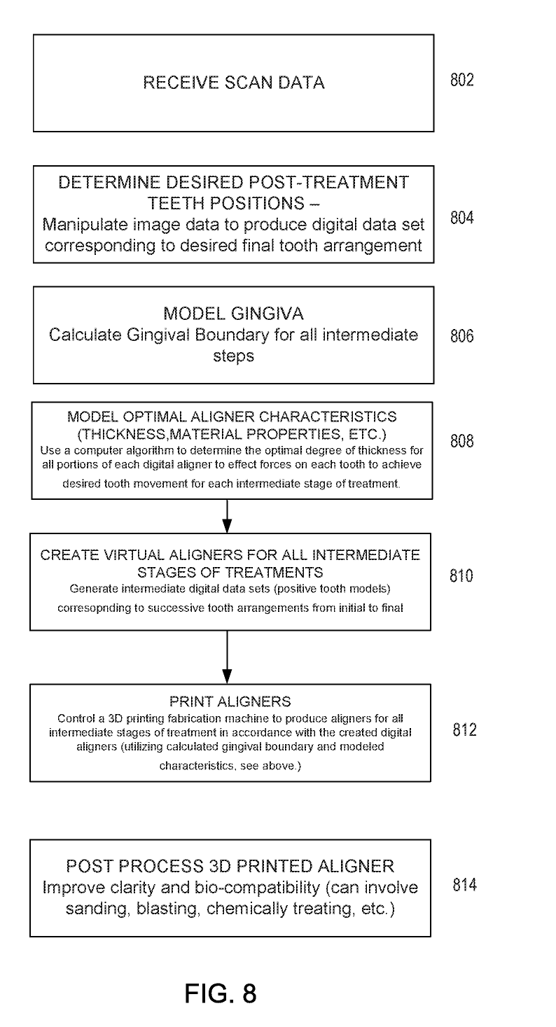

FIG. 8 shows an illustrative flow chart according to certain embodiments. Step 802 shows a system according to certain embodiments may receive scan data. Step 804 shows that the system may determine desired post-treatment teeth position and manipulate image data to produce digital data set corresponding to a desired final tooth arrangement. Step 806 shows that the system may model a patient's gingiva by calculating gingival boundary for one, more than or even all intermediate steps.

Step 808 shows that the system may model optimal appliance characteristics (thickness, material properties, etc.). Such modeling may include using a computer algorithm to determine the optimal degree of thickness for all portions of each digital appliance to effect forces on each tooth to achieve desired tooth movement for each intermediate stage of treatment. This step can be automated and system-driven, or, alternatively, manual input can be received from an authorized user of the system to alter thickness levels.

Step 810 shows creating virtual appliances for preferably all intermediate stages of treatments and generating intermediate digital data sets (positive tooth models) corresponding to successive tooth arrangements from initial stage to final stage. This step can create digital appliances incorporating the calculated gingival boundary and modeled appliance characteristics for preferably all intermediate stages.

Step 812 shows printing appliances by controlling a 3D printing fabrication machine to produce appliances for all intermediate stages of treatment in accordance with the created digital appliances (utilizing calculated gingival boundary and modeled characteristics, see above.).

Step 814 shows post-processing of a 3D printed appliance. Such post-processing may improve clarity and biocompatibility and may involve sanding, blasting, chemically treating and/or any other suitable post-processing.

One of ordinary skill in the art will appreciate that the elements and steps shown and described herein may be utilized and/or performed in other than the recited system and/or order and that one or more elements illustrated may be optional. The methods of the above-referenced embodiments may involve the use of any suitable elements, elements, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods of manufacture of dental appliances and other appliances using 3D printing, and products produced therefrom, have been provided. Persons skilled in the art will appreciate that the present invention can be practiced by other than the described embodiments, which are presented for purposes of illustration rather than of limitation, and that the present invention is limited only by the claims that follow.

What is claimed is:

1. A unitary shell appliance for use in a course of treatment for a dental patient and being of controlled thickness;
the unitary shell appliance being formed to present cavities configured to receive teeth of one of an upper or lower arch of the patient when the appliance is positioned on the patient;
the appliance further being formed to have a first portion engageable with any tooth selected from the arch of the patient on which the appliance is to be positioned and a second portion associated with another tooth of the arch; and
the first portion of the appliance being formed to be of a thickness selected from a range of thicknesses to be different from the thickness of the second portion of the appliance to apply a level of force on the selected tooth different from the level of force applied by the second portion on the other tooth.

2. The unitary shell appliance of claim 1 wherein the first portion of the appliance is engageable with a substantial portion of the surface of the selected tooth when the appliance is positioned on the patient.

3. The unitary shell appliance of claim 1 wherein the second portion of the appliance is positioned adjacent to the first portion of the appliance.

4. The unitary shell appliance of claim 1 wherein the second portion of the appliance is positioned at a location spaced apart from a location of the first portion of the appliance.

5. The unitary shell appliance of claim 1 wherein the first portion at its periphery defines a distinct line of demarcation between the thickness of first portion and the thickness of the second portion.

6. The unitary shell appliance of claim 1 wherein the first portion at its periphery defines a controlled gradient of thicknesses relative to the thickness of the second portion.

7. A unitary shell appliance for use in a course of treatment for a dental patient missing one or more teeth, thereby leaving a void in one of an upper or lower arch of the patient, the unitary shell appliance comprising:
cavities configured to receive all teeth of an upper or lower arch of the patient when the unitary shell appliance is positioned on the patient; and
an outer surface at the void simulating the surface of a tooth being present at the void and a projection extending inwardly relative to the outer surface of the unitary shell appliance at the void into the void to at least partially fill the void.

8. The unitary shell appliance of claim 7 wherein the outer surface of the appliance at the void presents wall portions and a crown portion formed of a material of a color similar to that of natural teeth.

9. The unitary shell appliance of claim 7 wherein the outer surface of the appliance at the void presents wall portions and a crown portion coated with a material of a color similar to that of natural teeth.

10. The unitary shell appliance of claim 7 wherein the projection substantially fills the void.

11. The unitary shell appliance of claim 7 wherein the projection is substantially solid throughout.

12. A unitary shell appliance for use in a course of treatment for a dental patient and being of controlled material properties, the shell appliance comprising:
cavities configured to receive teeth of one of an upper or lower arch of the patient when the unitary shell appliance is positioned on the patient; and
a first portion and a separate and distinct second portion spaced apart from the first portion, with the material properties of the first portion being selected from a range of properties to be different from the material properties of the second portion.

13. The unitary shell appliance of claim 12 wherein the appliance has a labial surface portion, a lingual surface portion and an intermediate portion between the surface portions, with the intermediate portion being of different material properties from those of the surface portions.

14. The unitary shell appliance of claim 12 wherein the appliance has a labial surface portion and a lingual surface portion, with the labial surface portion being of different material properties from those of the lingual surface portion.

15. The unitary shell appliance of claim 12 wherein the first portion is closely adjacent the second portion of the appliance.

16. The unitary shell appliance of claim 12 wherein the first portion is at a location spaced apart from a location of the second portion.

17. The unitary shell appliance of claim 12 wherein the unitary shell appliance has material properties that include toughness, flexibility, coefficient of friction, hardness, tear resistance, tensile strength, compressive strength, color, transparency, translucency, elasticity, pliability and/or chemical resistivity.

18. The unitary shell appliance of claim 12 wherein the first portion at its periphery defines a distinct line of demarcation between the material properties of the first portion and the material properties of the second portion.

19. The unitary shell appliance of claim 12 wherein the first portion at its periphery defines a controlled gradient of properties relative to the properties of the second portion.
